(19) United States
(12) Patent Application Publication
(10) Pub. No.: US 2024/0035382 A1
(43) Pub. Date: Feb. 1, 2024

(54) FLUIDIZED COAL MINING METHOD FOR IMPLEMENTING CO2 UNDERGROUND STORAGE

(71) Applicant: CHINA UNIVERSITY OF MINING AND TECHNOLOGY, BEIJING, Beijing (CN)

(72) Inventors: Yang JU, Beijing, China (CN); Peng LIU, Beijing, China (CN); Yu FEI, Beijing, China (CN); Xiaodong NIE, Beijing, China (CN); Yan ZHU, Beijing, China (CN)

(73) Assignee: CHINA UNIVERSITY OF MINING AND TECHNOLOGY, BEIJING, Beijing, China (CN)

(21) Appl. No.: 18/277,925

(22) PCT Filed: Jun. 30, 2021
(86) PCT No.: PCT/CN2021/103578

§ 371 Date: Aug. 18, 2023

(51) Int. Cl. E21C 37/18; E21B 41/00; E21B 43/28; E21F 15/00

(52) U.S. Cl. CPC E21C 37/18; E21B 41/0064; E21B 43/28; E21F 15/005

(57) ABSTRACT

A fluidized coal mining method for implementing CO₂ underground storage, includes mining area division, tunneling mining, filling and supporting, roof and bottom plate sealing, and boundary surrounding rock sealing. A goaf formed by a mining device after tunneling and mining along a mining strip is filled and supported, and filling and supporting can form a high-strength supporting wall body, which not only provides an effective supporting effect for roof and bottom plate rocks, but also forms a filled and supported wall body; a space for underground storage of CO₂ is formed between adjacent filled and supported wall bodies; at the same time, the mining device further seals the roof and a bottom plate of the goaf, and seals boundary surrounding rocks of a mine field, so that the entire mine field forms a whole closed space for the underground storage of CO₂ after mining is completed.

### FIELD

The present application relates to the technical field of mineral resources mining, and in particular to a fluidized coal mining method for realizing CO₂ underground storage.

### BACKGROUND

Fluidized coal in-situ mining technology is different from traditional solid energy mining technology, which realizes the underground unmanned and intelligent energy mining.

During the development and utilization of fossil energy, a large amount of carbon emissions may occur, causing a series of environmental problems. Thus, how to reduce the harm of carbon emissions to the environment has become a key issue in current energy development and utilization. One of the most important ways is to safely and effectively store CO₂ underground. Compared with the method of storing CO₂ underground in saline water, it is of a great potential to make full use of underground goaf to store CO₂ underground.

Therefore, how to design a fluidized excavation method that can realize CO₂ underground storage has become a technical problem to be solved urgently by those skilled in the art.

### SUMMARY

In view of this, a fluidized coal mining method for realizing CO₂ underground storage is provided according to the present application, so as to realize CO₂ underground storage.

In order to achieve the above object, the following technical solutions are provided according to the present application.

A fluidized coal mining method for realizing CO₂ underground storage, including the following steps:
1) dividing a mining field into at least one mining area, and dividing the mining area into multiple mining strips of equal width;
2) drilling a main shaft extending to the mining field, and mounting excavation equipment through the main shaft;
3) arranging an energy transmission pipeline on each of the mining strips for transmitting energy to the excavation equipment and capable of transmitting the electric energy obtained by the excavation equipment from coal transformation to the ground;
4) the excavation equipment performing full-section excavation along the mining strip, and the excavation equipment transporting the converted electric energy to the ground through the energy transmission pipeline, the main shaft conveying materials for backfilling, supporting and sealing a roof, floor and boundary surrounding rocks into the excavation equipment, the excavation equipment backfilling and supporting the goaf where at least one of the two adjacent mining strips is located at a rear end of the excavation equipment to form a backfilling support wall, a space for storing CO₂ and waste gas emitted by the excavation equipment in-situ during the power generation process and artificially injected CO₂ is formed between the adjacent backfilling support walls, in which the backfilling support wall can adsorb the CO₂ gas;
5) taking closure measures on the roof and floor of the goaf at the rear end of the excavation equipment;
6) taking closure measures for the boundary surrounding rocks of the mining field.

Preferably, in the above fluidized coal mining method for realizing CO₂ underground storage, the materials used for backfill and support in step 4) include coarse aggregate, mixture, accelerator, calcium carbonate and gangue sorted by the excavation equipment. The coarse aggregate, mixing material, quick-setting agent and calcium carbonate are transported to the backfilling support bunker of the excavation equipment through the main shaft, the coarse aggregate, the mixing material, the quick-setting agent, the calcium carbonate and the gangue are stirred in the backfilling support bunker and pumped to the backfilling position through the conveying pipeline of the backfilling support bunker.

Preferably, in the above fluidized coal mining method for realizing CO₂ underground storage, in case that a thickness of the coal seam for the mining strip is larger than the excavation section of the excavation equipment, the step 4) specifically includes:
the excavation equipment excavates in layers from bottom to top in the coal seam, and the excavation equipment transports the converted electric energy to the ground through the energy transmission pipeline. The excavation equipment sequentially carries out full-section excavation mining on the lower layer, the middle layer and the upper layer of the coal seam according to the mining strip divided in the step 1),
the excavation equipment fills and supports all the mining strips in the lower layer and the middle layer of the coal seam in the goaf at the rear end of the excavation equipment,
the excavation equipment fills and supports the goaf where at least one of the two adjacent mining strips at the upper layer of the coal seam is located at the rear end of the excavation equipment to form a backfilling support wall, a space is formed between adjacent backfilling support walls for storing artificially injected CO₂ and emitted CO₂ and waste gas in the process of in-situ power generation from the excavation equipment. The backfilling support wall can adsorb the CO₂ gas.

Preferably, in the above fluidized coal mining method for realizing CO₂ underground storage, the step 7) following the step 6), that is, the excavation equipment closes the main shaft.

Preferably, in the above fluidized coal mining method for realizing CO₂ underground storage, the excavation equipment includes a first excavation bunker, a first separation bunker, a first transformation bunker, a first energy storage bunker, a backfilling support bunker, a second energy storage bunker, a second transformation bunker, a second separation bunker and a second excavation bunker which are sequentially connected in series. The excavation equipment may excavate along an excavation direction of the first excavation bunker or the second excavation bunker.

Preferably, in the above coal fluidized mining method for realizing CO₂ underground storage, in the step 4), when the excavation equipment performs full-section excavation along the mining strip, it specifically includes:
opening a shield cutter head of the first excavation bunker on one side of the excavation equipment, and performing excavation on one of the mining strips;
closing the shield cutter head of the first excavation bunker of the excavation equipment after the excavation construction of the mining strip is completed, opening the shield cutter head of the second excavation bunker on the other side of the excavation equipment and adjusting the excavation direction of the shield cutter head, and excavating the adjacent mining strip;
repeating the above process until all the mining strips in the mining area are excavated.

Preferably, the above fluidized coal mining method for realizing CO₂ underground storage further includes a step 8), that is, after all the mining strips in the mining area are excavated and filled, an impermeable wall is set at the position where the main shaft is set in the mining area.

It can be seen from the above technical solution that the coal fluidization excavation method for realizing CO₂ underground storage provided by the present application includes mining area division, excavation mining, backfilling and supporting, roof and floor sealing, and boundary surrounding rock sealing. This solution adopts backfilling and supporting the goaf formed after the excavation equipment is excavated along the mining strip, the backfilling support may form a high-strength support wall, which not only has an effective supporting effect on the roof and floor, but also forms a backfilling support wall. A space for underground storage of CO₂ is formed between adjacent backfilling support walls. The excavation equipment further seals the roof and floor of the goaf and the boundary surrounding rock of the mining field, so that the whole mining field forms an underground closed space for storing CO₂ after the excavation is completed. CO₂ and other waste gases generated in the power generation process of excavation equipment are directly discharged in situ, and sealed in the above space, so as to realize underground storage of CO₂, ensure that the polluted gas discharged by excavation equipment does not leave the ground, and reduce the harm of carbon emissions to the environment.

### BRIEF DESCRIPTION OF THE DRAWINGS

For more clearly illustrating the technical solutions of embodiments of the present application or in the conventional technology, drawings referred to for describing the embodiments or the conventional technology will be briefly described hereinafter. Apparently, the drawings in the following description are only several examples of the present application, and for those skilled in the art, other drawings may be obtained based on these drawings without any creative efforts.

FIG. 1 is a schematic structural diagram of mining field division provided by an embodiment of the present application;

FIG. 2 is a schematic structural diagram of an excavation equipment provided by an embodiment of the present application;

FIG. 3 is a schematic structural diagram of a backfilling support provided by an embodiment of the present application;

FIG. 4 is the structural schematic diagram of the backfilling support of the mining strip in a certain mining area provided by the first embodiment of the present application;

FIG. 5 is the structural schematic diagram of the backfilling support of the mining strip in a certain mining area provided by the second embodiment of the present application;

FIG. 6 is the structural schematic diagram of the backfilling support of the mining strip in a certain mining area provided by the third embodiment of the present application;

FIG. 7 is the structural schematic diagram of the backfilling support of the mining strip in a certain mining area provided by the fourth embodiment of the present application;

FIG. 8 is a schematic structural diagram of backfilling support when the thickness of coal seam exceeds the excavation section of excavation equipment provided by the embodiment of the present application;

FIG. 9 is a flow chart of a fluidized coal mining method for realizing CO₂ underground storage provided by the first embodiment of the present application;

FIG. 10 is a flow chart of a fluidized coal mining method for realizing CO₂ underground storage provided by the second embodiment of the present application.

### IN THE DRAWINGS

1 mining field, 2 mining strip, 3 main shaft, 4 energy transmission pipeline, 5 excavation equipment, 51 first excavation bunker, 52 first separation bunker, 53 first transformation bunker, 54 first energy storage bunker, 55 second energy storage bunker, 56 second transformation bunker, 57 second separation bunker, 58 second excavation bunker, 59 backfilling support bunker, 60 backfilling support wall.

### DETAILED DESCRIPTION OF THE EMBODIMENTS

A fluidized coal mining method for realizing CO₂ underground storage is disclosed according to the present application, so as to realize CO₂ underground storage.

Technical solutions in the embodiments of the present application are clearly and completely described hereinafter in conjunction with the drawings in the embodiments of the present application. Apparently, the embodiments described in the following are only some embodiments of the present application, rather than all embodiments. Based on the embodiments in the present application, all of other embodiments, made by the person skilled in the art without any creative efforts, fall into the scope of protection of the present application.

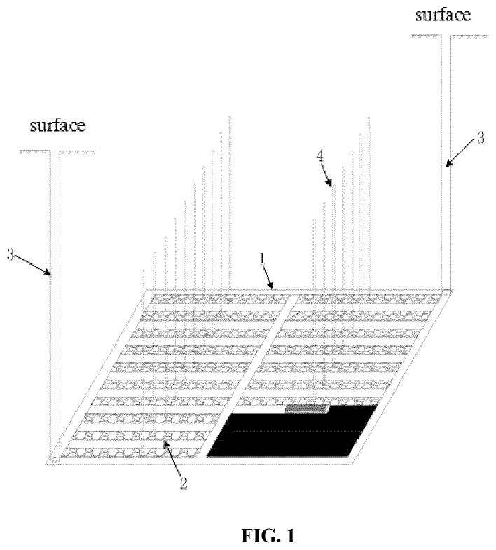

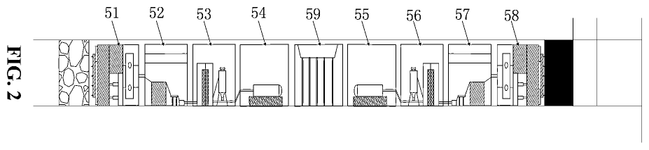

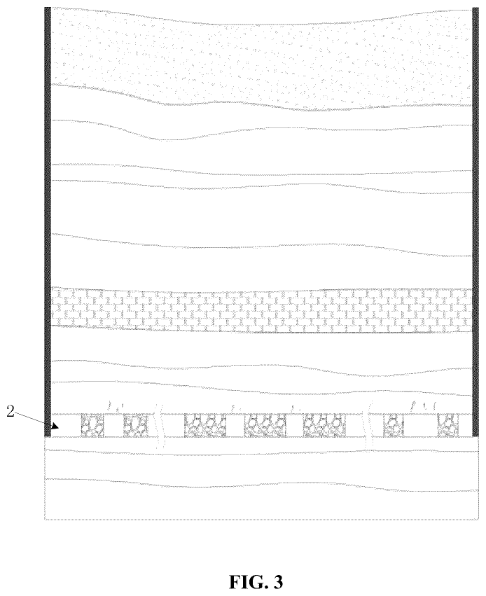

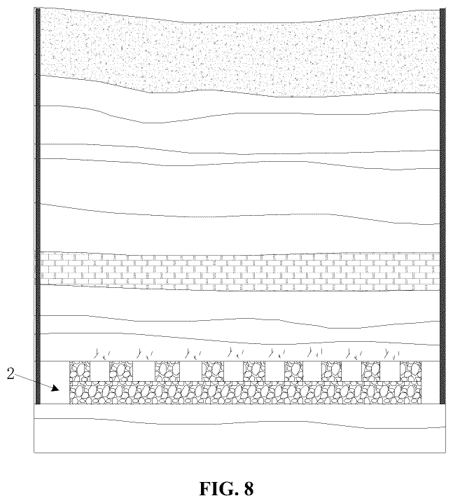

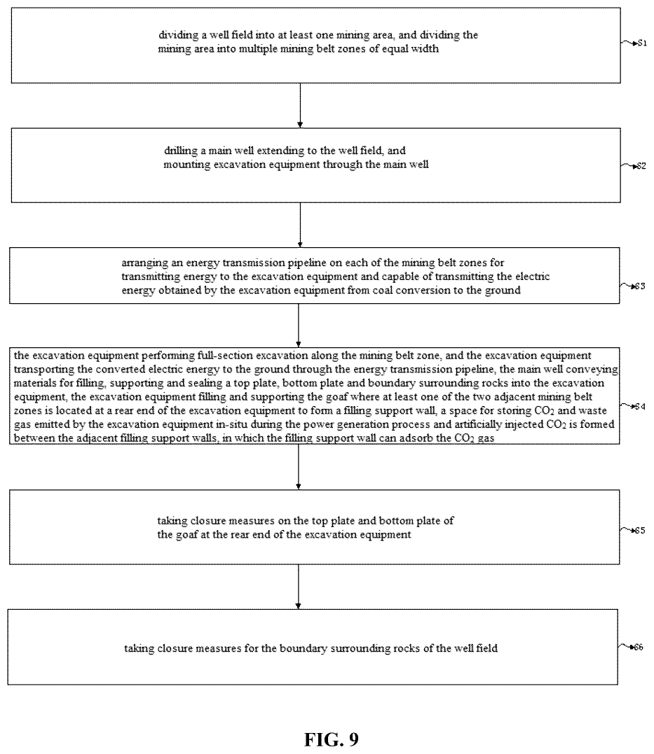

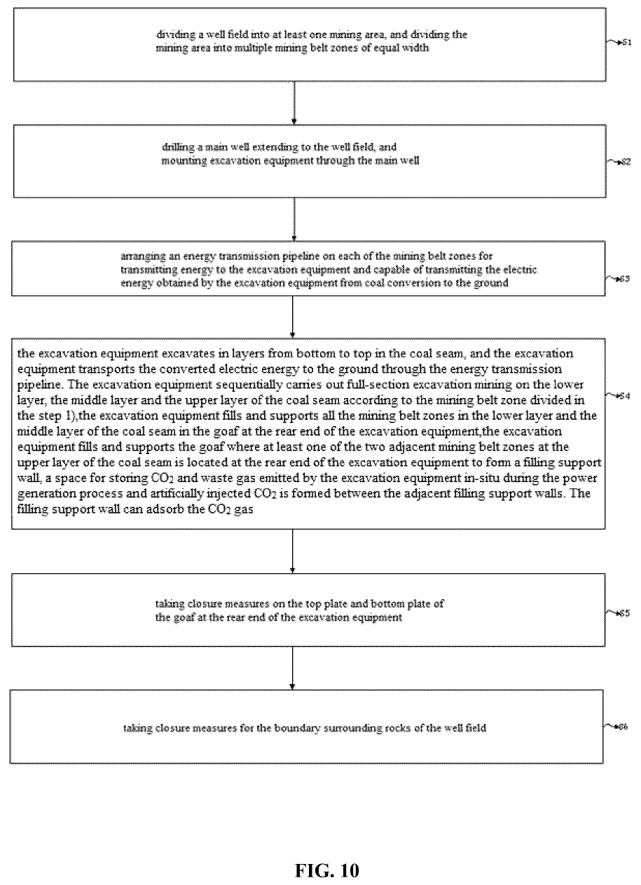

Reference is made to FIG. 1 to FIG. 10.

A fluidized coal mining method for realizing CO₂ underground storage is disclosed according to the present application, including the following steps:
1) dividing a mining field into at least one mining area, and dividing the mining area into multiple mining strips of equal width;
2) drilling a main shaft extending to the mining field, and mounting excavation equipment through the main shaft;
3) arranging an energy transmission pipeline on each of the mining strips for transmitting energy to the excavation equipment and capable of transmitting the electric energy obtained by the excavation equipment from coal transformation to the ground;
4) the excavation equipment performing full-section excavation along the mining strip, the excavation equipment transmitting the converted electric energy to the ground through the energy transmission pipeline, and the main shaft transmitting materials for backfilling and supporting to the excavation equipment, the excavation equipment backfilling and supporting the goof at the rear end of the excavation equipment to form a backfilling support wall, that is, the excavation equipment 5 fills and supports at least one of the two adjacent mining strips 2, a space for storing CO₂ and waste gas emitted by the excavation equipment 5 in-situ during the power generation process and artificially injected CO₂ is formed between the adjacent backfilling support walls;
it should be noted here that, that the mining strips 2 in each mining area 1 are filled and supported with spaces may specifically be: one of the two adjacent mining strips can be filled, that is, one mining strip is spaced for backfilling and support, the backfilling support may also be carried out at spaces of two mining strips, or at spaces of three or more mining strips, the spaced backfilling supports can be equally spaced backfilling supports or unequally spaced backfilling supports, the final result is that not all mining strips in a certain mining area are filled and supported, at least one mining strip in a certain mining area is not filled and supported, which can form a space in the mining area for sealing the CO₂ and waste gas discharged in situ by the excavation equipment 5 in the power generation process and the artificially injected CO₂, the location of the specific backfilling and support is determined according to the excavation conditions of different sites;
5) taking closure measures on the roof and floor of the goaf at the rear end of the excavation equipment 5;
6) taking closure measures for the boundary surrounding rock of the mining field.

Step 1) is the step of dividing the mining field. The mining field division can facilitate the excavation and mining of the excavation equipment in the mining field. In a specific embodiment of this solution, the mining field is divided into at least one quadrilateral mining area, the long side of the quadrilateral mining area extends along the strike direction of the coal seam, and the short side of the quadrilateral mining area extends along the inclination direction of the coal seam.

For a mining field with regular boundaries, only one rectangular mining area can be arranged to cover all the boundaries of the mining field. For a mining field with irregular boundaries, it can be divided into two mining areas, three mining areas, or even more mining areas. No matter the mining field is divided into several mining areas, it should cover the whole range of the mining field as much as possible.

The mining field division further includes dividing each excavation area, each mining area is divided into multiple mining strips with equal widths, the mining strips are parallel to the broad side of the mining area and distributed along the length of the mining area. Specifically, appropriate excavation equipment is selected according to the size of the mining strip in the mining area, and the section size of the excavation equipment is approximately the same as the size of the mining strip.

The main shaft is drilled, which extends to the mining field. The main shaft is used to transport excavation equipment, and to transport materials for backfilling, supporting and sealing the roof, floor and boundary surrounding rocks into the excavation equipment during the excavation process.

In this solution, two main shafts are provided, and the two main shafts are set at the boundary of the mining field and are respectively set at two diagonal positions of the mining field. As shown in FIG. 1, the mining field is divided into two quadrilateral mining areas, and the two quadrilateral mining areas form a large quadrilateral mining field. The two main shafts are located at the two diagonal positions of the large quadrilateral mining field.

One of the two main shafts is used as the starting point of excavation, and the other of the two main shafts is used as the end point of excavation.

Each mining strip is provided with an energy transmission pipeline. The energy transmission pipeline is used for transmitting energy to the excavation equipment and capable of transmitting the electric energy obtained by the excavation equipment from coal transformation to the ground.

In step 4), the excavation equipment performs full-section excavation along the length extension direction of the mining strip, and the excavation equipment transports the converted electrical energy to the ground through energy transmission pipelines.

In case that the excavation equipment excavates, the main shaft conveys materials for backfilling and supporting into the excavation equipment, the excavation equipment pumps the material to the goaf at the rear end of the excavation equipment, and fills and supports the goaf. In this solution, the material used for backfilling and supporting is the material capable of absorbing CO₂ gas, which has high strength and can absorb CO₂ gas after solidification.

After the backfilling support and the sealing of the roof, floor and boundary surrounding rock are completed in the mining area. All main shafts need to be closed to ensure that the underground mining area is an independent and closed space.

The backfilling support is explained here. The backfilling support supports along the length direction of the mining strip, the backfilling support can be a section-by-section structure along the length extension direction of the mining strip, or it can be a strip-shaped structure that fills the whole mining strip. However, at least one of two adjacent mining strips is supported by backfilling, and the other one may or may not be supported by backfilling. However, after the excavation of the entire mining area is completed, there must be some mining strips that have not been filled and supported. The space of the goof mining strip which is not filled and supported can be used as a space for sealing gas, which includes CO₂ and waste gas discharged in situ by the excavation equipment 5 in the process of power generation and artificially injected CO₂.

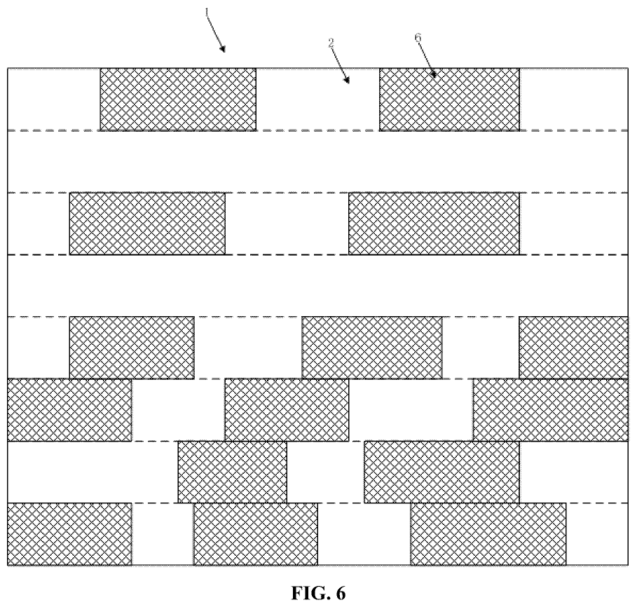

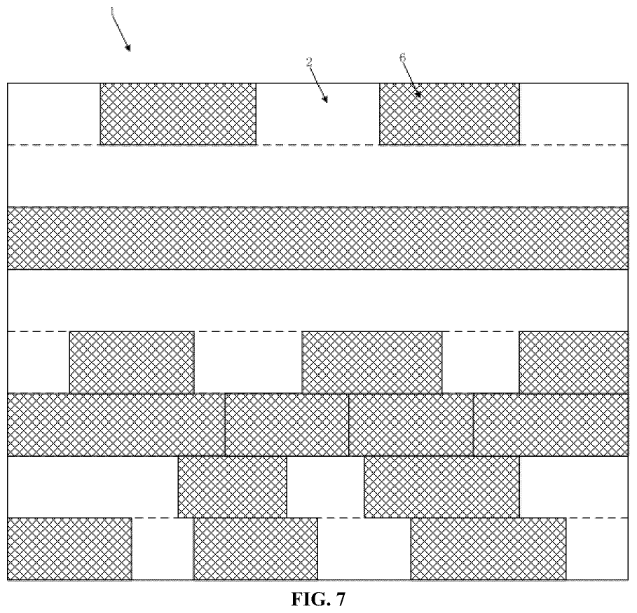

In the embodiment where the backfilling support is a section-by-section structure along the length extension direction of the mining strip, as shown in FIG. 6 and FIG. 7, each section of backfilling support forms a backfilling support wall. The adjacent backfilling support walls include not only the adjacent backfilling support structures located in the same mining strip, but also the adjacent backfilling support structures along the direction perpendicular to the length extension of the mining strip. In this embodiment, the backfilling and supporting structure in the mining area forms a structure similar to a labyrinth.

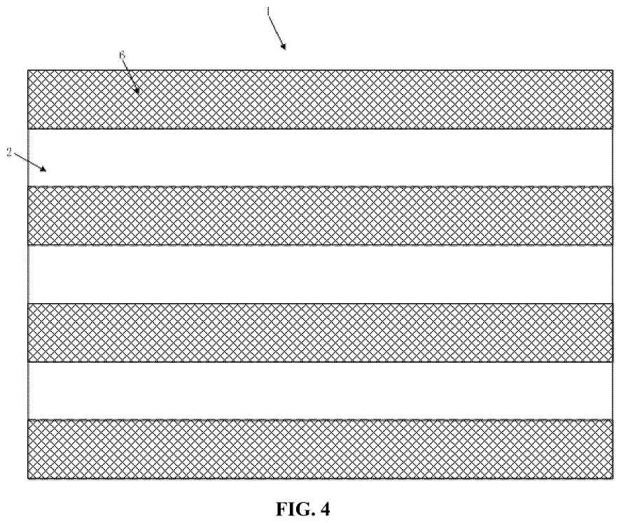

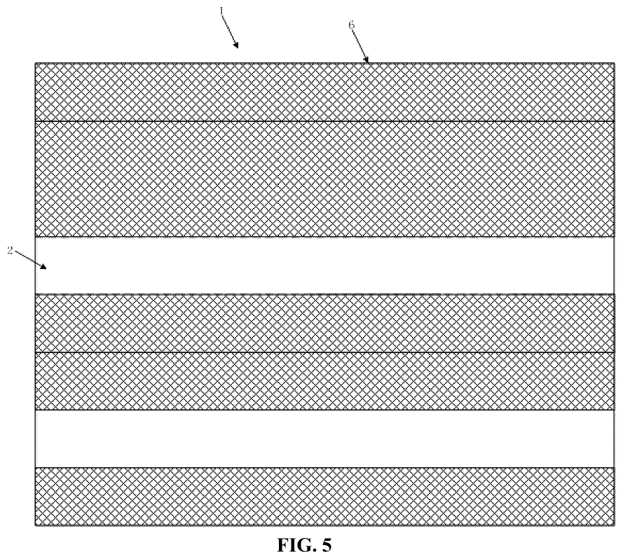

In the embodiment where the backfilling support is a long strip structure that fills the whole mining strip, as shown in FIG. 4 and FIG. 5, the adjacent backfilling support walls are two backfilling support structures located close to each other along the extension direction perpendicular to the length of the mining strip.

A space for storing CO₂ and waste gas emitted by the excavation equipment 5 in-situ during the power generation process and artificially injected CO₂ is formed between the adjacent backfilling support walls 6, the backfilling support wall 6 may also adsorb CO₂. The coal fluidization excavation method for realizing CO₂ underground storage disclosed by this solution includes mining area division, excavation mining, backfilling and supporting, roof and floor sealing, and boundary surrounding rock sealing. In this solution, the goaf formed after the excavation equipment is excavated along the mining strip is filled and supported. The backfilling support may form a high-strength support wall, which not only has an effective supporting effect on the top and bottom rocks, but also forms continuous backfilling support wall 6 parallel to the mining strip. A space for underground storage of CO₂ is formed between adjacent backfilling support walls 6. The excavation equipment further seals the roof and floor of the goaf and the boundary surrounding rock of the mining field, so that the whole mining field forms an underground closed space for storing CO₂ after the excavation is completed. CO₂ and other waste gases generated in the power generation process of excavation equipment are directly discharged in situ, and artificially injected CO₂ is sealed in the above space, so as to realize underground storage of CO₂, ensure that the polluted gas discharged by excavation equipment does not leave the ground, and reduce the harm of carbon emissions to the environment.

Step 5) is used to close the roof and the floor, Step 6) is used to close the boundary surrounding rock, so that the entire mining area forms a closed space.

The closure of the roof and floor of the mining strip with the backfilling support wall is carried out during the process of supporting and backfilling the mining strip. In the process of backfilling and supporting, the floor and the roof are closed, and no separate closure measures are required; the closure of the roof and floor of the mining strip without backfilling support walls is that the excavation equipment closes the roof and floor of the goaf located at the rear end of the excavation equipment during the excavation process.

The closure of the boundary surrounding rock is also carried out during the excavation process of the mining strip. As long as the boundary surrounding rock is encountered during the excavation process, measures are taken to close the boundary surrounding rock mining area to reduce the amount of CO₂ gas overflowing the mining area through the boundary surrounding rock.

Steps 4), 5) and 6) in this solution are not limitations on the sequence of operation steps, the sequence of steps 4), 5) and 6) can be adjusted according to actual requirements, so that the mining area forms a space for underground storage of CO₂.

In the process of advancing the excavation equipment, Using the packaging system of the excavation equipment, the impermeable closure material transported from the ground to the excavation bunker is sprayed or mounted on the surface of the overlying layer, floor and surrounding rock in the goaf, and ensures that the closure material can be closely attached to the surface of the overlying layer, the floor and the surrounding rock, and improve the permeability of the roof and floor of the goaf, and further ensures that CO₂ gas may not leak and filter along the overlying layer, floor and surrounding rock when CO₂ is sealed in the later stage.

The materials used for backfilling and supporting in step 4) include coarse aggregate, mixing material, quick-setting agent, calcium carbonate and gangue sorted by the excavation equipment. The coarse aggregate, mixing material, quick-setting agent and calcium carbonate are transported to the backfilling support bunker of the excavation equipment from the ground through the main shaft. In addition, the materials are fully stirred with the gangue sorted by the separation bunker of the excavation equipment to prepare the quick-setting and high-strength backfilling slurry. The material has high initial setting strength, and contains calcium sources such as calcium carbonate. After solidification, it can chemically react with CO₂ to adsorb CO₂ gas in the mining area.

The backfilling slurry is quickly pumped to the backfilling position through the transportation pipeline of the backfilling support bunker for unloading and compaction. After the backfilling body is cured, a high-strength support wall is formed, the wall may not only effectively support the roof and the floor, but may also effectively absorb waste gas such as CO₂.

Since the mixing of the backfilling slurry is carried out in the backfilling support bunker of the excavation equipment, the transportation distance of the backfilling slurry is greatly shortened. Therefore, the selection of quick-setting backfilling slurry may not only avoid the problem of pipe closure and difficult transportation, but also ensure that the backfilling slurry can quickly solidify to achieve the support strength, and achieve the purpose of backfilling with mining.

Backfilling and supporting at distances in the mining strip may also improve the economic benefits in the excavation process and provide more sufficient underground space for CO₂ storage.

The specific backfilling support solution is determined according to the stress conditions of surrounding rock, and it is necessary to ensure that the strength and spacing of backfilling support can meet the requirements of roof control, so as to ensure that the critical layer may not break and sink. In this solution, the backfilling and supporting operation and coal seam excavation are carried out simultaneously.

When the thickness of the coal seam is larger than the excavation section of the excavation equipment, it is necessary to adopt a bottom-up excavation solution, which may ensure the safety of excavation.

For the lower coal seam and the middle coal seam which are first excavated, the belt excavation solution is still adopted, and the mining strip is divided according to the division structure in step 1). However, the backfilling support solution of spaced mining strips is no longer implemented between adjacent mining strips, but all mining strips are filled and supported to ensure that the whole goaf is filled with backfilling support materials. The goaf is completely filled and supported, and the last-excavated uppermost coal seam is still supported by the solution of spaced backfilling and support described above.

The fluidized coal mining method for realizing CO₂ underground storage disclosed in this solution further includes step 7) after step 6), that is, closing the main shaft 3 to form a closed space in the entire mining area.

The excavation equipment in this solution includes a first excavation bunker 51, a first separation bunker 52, a first transformation bunker 53, a first energy storage bunker 54, a backfilling support bunker 59, a second energy storage bunker 55, a second transformation bunker 56, a second separation bunker 57 and a second excavation bunker 58 which are sequentially connected in series. Based on the cooperation and cooperative operation of systematic and intelligent control, the coal excavation and utilization mode integrating resource excavation, transformation and utilization, backfilling and supporting is realized.

The coal excavation operation is mainly carried out by the first excavation bunker and the second excavation bunker, and the full-section coal seam excavation is completed by the shield excavation method.

Considering that the length of the excavation equipment is long and the turning radius is large, it is impossible to turn around for excavating adjacent mining strips, so the first excavation bunker and the second excavation bunker are arranged in the excavation equipment in a symmetrical structure.

In the step 4), when the excavation equipment 5 performs full-section excavation along the mining strip 2, it specifically includes:
opening the shield cutter head of the first excavation bunker 51 on one side of the excavation equipment 5, and perform excavation on one of the mining strips 2;
closing the shield cutter head of the first excavation bunker 51 of the excavation equipment 5 after the excavation construction of the mining strip 2 is completed, opening the shield cutter head of the second excavation bunker 58 on the other side of the excavation equipment 5 and adjusting the excavation direction of the shield cutter head, and excavating the adjacent mining strip 2 to be excavated;
repeating the above process until all the mining strips 2 in the mining area are excavated.

During the excavation process of the excavation equipment, auxiliary rock breaking devices such as microwave radiation or water jet can be set at the front end of the shield cutter head. Before the shield cutter head cuts the coal wall, artificial cracks are created in the coal wall to avoid the phenomenon of knife jamming or driving delay.

The fluidized coal mining method for realizing CO₂ underground storage disclosed in this solution further includes step 8): after all the mining strips in the mining area are excavated and filled, the impermeable wall is set at the location where the main shaft is set in the mining area to form a closed space in the mining area.

Based on the above description of the disclosed embodiments, those skilled in the art can implement or deploy the present application. Various modifications to these embodiments are obvious to a person skilled in the art, the general principles defined herein may be implemented in other embodiments without departing from the spirit and scope of the present application. Therefore, the present application is not limited to the embodiments described herein, but should be in accordance with the broadest scope consistent with the principle and novel features disclosed herein.

What is claimed is:

1. A fluidized coal mining method for realizing CO₂ underground storage, comprising the following steps:
1) dividing a mining field into at least one mining area, and dividing the mining area into a plurality of mining strips of equal width;
2) drilling a main shaft extending to the mining field, and mounting excavation equipment via the main shaft;
3) arranging an energy transmission pipeline on each of the mining strips for transmitting energy to the excavation equipment and transmitting the electric energy obtained by the excavation equipment from coal transformation to the ground;
4) the excavation equipment performing full-section excavation along the mining strip, and the excavation equipment transporting the converted electric energy to the ground through the energy transmission pipeline, the main shaft conveying materials for backfilling, supporting and sealing a roof, a floor and boundary surrounding rocks into the excavation equipment, the excavation equipment backfilling and supporting a goaf where at least one of the two adjacent excavation is located at a rear end of the excavation equipment to form a backfilling support wall,
wherein a space for storing CO₂ and waste gas emitted by the excavation equipment in-situ during the power generation process and artificially injected CO₂ is formed between the adjacent backfilling support walls, the backfilling support walls adsorb CO₂ gas;
5) taking closure measures on the roof and floor of the goaf at the rear end of the excavation equipment;
6) taking closure measures for the boundary surrounding rocks of the mining field.

2. The fluidized coal mining method for realizing CO₂ underground storage according to claim 1, wherein the materials for backfilling and supporting in step 4) comprise coarse aggregate, mixing material, quick-setting agent, calcium carbonate and gangue sorted by the excavation equipment, the coarse aggregate, mixing material, quick-setting agent and calcium carbonate are transported to the backfilling support bunker of the excavation equipment through the main shaft, the coarse aggregate, the mixing material, the quick-setting agent, the calcium carbonate and the gangue are stirred in the backfilling support bunker and pumped to the backfilling position through the conveying pipeline of the backfilling support bunker.

3. The fluidized coal mining method for realizing CO₂ underground storage according to claim 1, wherein in case that a thickness of the coal seam in the mining strip is larger than an excavation section of the excavation equipment, the step 4) specifically comprises:
the excavation equipment excavates in layers from bottom to top in the coal seam, and the excavation equipment transports the converted electric energy to the ground through the energy transmission pipeline, wherein the excavation equipment sequentially carries out full-section excavation mining on the lower layer, the middle layer and the upper layer of the coal seam according to the mining strips divided in the step 1),
wherein the excavation equipment fills and supports all the mining strips in the lower layer and the middle layer of the coal seam in the goaf at the rear end of the excavation equipment,
wherein the excavation equipment fills and supports the goaf where at least one of the two adjacent mining strips at the upper layer of the coal seam is located at the rear end of the excavation equipment to form a backfilling support wall, a space for storing CO₂ and waste gas emitted by the excavation equipment in-situ during the power generation process and artificially injected CO₂ is formed between the adjacent backfilling support walls, and the backfilling support walls adsorb the CO₂ gas.

4. The fluidized coal mining method for realizing CO₂ underground storage according to claim 1, further comprising a step 7) following the step 6), the excavation equipment closes the main shaft.

5. The fluidized coal mining method for realizing CO₂ underground storage according to claim 1, wherein the excavation equipment comprises a first excavation bunker, a first separation bunker, a first transformation bunker, a first energy storage bunker, a backfilling support bunker, a second energy storage bunker, a second transformation bunker, a second separation bunker and a second excavation bunker which are sequentially connected in series, the excavation equipment is configured to excavate along an excavation direction of the first excavation bunker or the second excavation bunker.

6. The fluidized coal mining method for realizing CO₂ underground storage according to claim 5, wherein in the step 4), when the excavation equipment performing full-section excavation along the mining strips, it specifically comprises:
opening a shield cutter head of the first excavation bunker on one side of the excavation equipment, and performing excavation on one of the mining strips;
closing the shield cutter head of the first excavation bunker of the excavation equipment after the excavation construction of the mining strip is completed, opening the shield cutter head of the second excavation bunker on the other side of the excavation equipment and adjusting the excavation direction of the shield cutter head, and excavating the adjacent mining strip to be excavated;
repeating the above process until all the mining strips in the mining area are excavated.

7. The fluidized coal mining method for realizing CO₂ underground storage according to claim 1, further comprising a step 8), after all the mining strips in the mining area are excavated and filled, setting an impermeable wall at the position where the main shaft is set in the mining area.
